(19) United States
(12) Patent Application Publication
(10) Pub. No.: US 2025/0241273 A1
(43) Pub. Date: Jul. 31, 2025

(54) ANIMAL FEEDER

(71) Applicant: Shawna Lynn Hogan, Port Sydney (CA)

(72) Inventor: Shawna Lynn Hogan, Port Sydney (CA)

(21) Appl. No.: 18/427,559

(22) Filed: Jan. 30, 2024

(51) Int. Cl. A01K 5/01

(52) U.S. Cl. CPC A01K 5/0114

(57) ABSTRACT

An animal feeder that is configured to facilitate feeding of an animal wherein the present invention is operable to mix a first food material with at least one additional food material and dispense into a container. The present invention includes a dry food module that has an interior volume operable to receive and store dry food material therein. The food material within the dry food module is transferred into a hopper module. A food supplement module is provided and is operably coupled to a milling module. The food supplement module receives a second food material which is transferred into the milling module and subsequently introduced into the hopper module. A second embodiment of the present invention includes a flexible delivery tube that has a rotatable auger member disposed therein that is configured to provide transfer of food from the animal feeder into a suitable container.

### FIELD OF THE INVENTION

The present invention relates generally to animal feeders, more specifically but not by way of limitation, an animal feeder that is configured to manage a large volume of food wherein the feeder of the present invention further includes milling and supplemental material introduction prior to depositing the final food mixture into a suitable container for feeding an animal.

### BACKGROUND

Millions of individuals own pets and as a result must engage in the regular care and feeding thereof. Common household pets are dogs and cats and these animals are fed on a routine basis. The feeding of the aforementioned types of pets is often conducted utilizing bowls. Bowls of various types and sizes are utilized to receive and provide access to the contents disposed therein which is most often food and water. A pet owner will routinely provide food to the pet at least twice a day. There are numerous types of pet bowls that are operable to provide food and drink to domestic pets such as but not limited to dogs and cats. Typically, most pet owners will place the pet bowls on the floor and will have to service the bowls on the floor. This can create issues for those pet owners that have physical disabilities or other conditions that inhibit access to the pet bowls.

Many pet food bags weigh twenty or more pounds which can be difficult for a user to manipulate and dispense into the food bowls. Furthermore, many animals requires alternate food types to be mixed together which again present further challenges when feeding a pet. Lastly, some pets require their food to be milled to a particular size in order to properly eat and digest their food.

Accordingly, there is a need for an animal feeder that can manage a large volume of food and providing milling and supplement automatically into a final food mixture that is deposited into a suitable container to provide to an animal for feeding.

### SUMMARY OF THE INVENTION

It is the object of the present invention to provide an animal feeder that is configured to provide a food mixture into a container for feeding of an animal wherein the present invention includes a dry food module.

Another object of the present invention is to provide an animal feeder that assists a user in managing a large weight of animal food wherein the dry food module in a first embodiment of the present invention includes a movable support tray.

A further object of the present invention is to provide an animal feeder that is configured to provide a food mixture into a container for feeding of an animal wherein the first embodiment of the present invention includes a hopper module operable to receive food from the dry food module.

Yet a further object of the present invention is to provide an animal feeder that assists a user in managing a large weight of animal food wherein the first embodiment of the present invention includes food supplement module that is configured to store and introduce a food supplement into the final food mixture delivered to the food container.

Still another object of the present invention is to provide an animal feeder that is configured to provide a food mixture into a container for feeding of an animal wherein the first embodiment of the present invention further includes a milling module configured to mill the food supplement into the final food mixture delivered to the animal.

An additional object of the present invention is to provide an animal feeder that assists a user in managing a large weight of animal food wherein a second embodiment of the present invention includes an auger delivery module.

Yet a further object of the present invention is to provide an animal feeder that is configured to provide a food mixture into a container for feeding of an animal wherein the first embodiment and second embodiment include housings manufactured from rigid materials and are configured to operate on AC and/or DC power having an integrated controller configured to provide operation of the present invention.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagrammatic perspective view of a first embodiment of the present invention; and

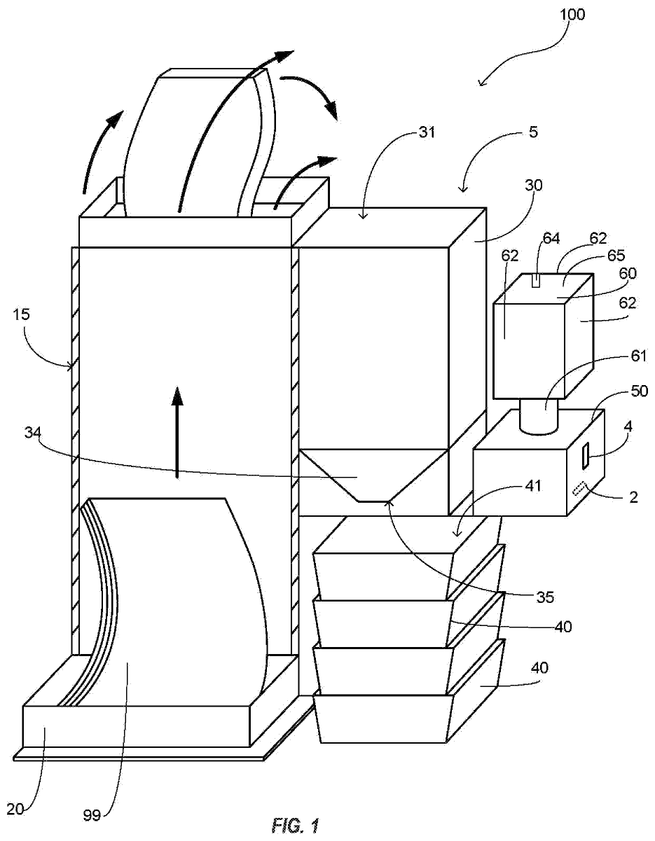

FIG. 2 is a diagrammatic perspective view of a second embodiment of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated an animal feeder 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the animal feeder 100 includes a first embodiment 5 and a second embodiment 10 being substantially similar as is further discussed herein. It should be understood within the scope of the present invention that the animal feeder 100 could be provided in alternate sizes so as to accommodate different volumes and/or weights of dry food. It should be further understood within the scope of the present invention that the animal feeder 100 can be configured to operate on AC and/or DC power.

The first embodiment 5 of the animal feeder 100 includes a dry food module 15. The dry food module 15 includes walls 16 defining an interior volume 16. The dry food module 15 includes a lower end 17 and upper end 18. A support tray member 20 is movably coupled to the dry food module 15 and is configured to traverse within the interior volume 16 thereof in an upwards-downwards direction. The support tray member 20 is mechanically coupled to the interior volume 16 utilizing suitable mechanical components operable to facilitate the movements of the support tray member 20 described herein. The support tray member 20 is configured to receive and retain an exemplary pet food bag 99 and provide management thereof. A pet food bag 99 is superposed on the support tray member 20 wherein the user of the animal feeder 100 will engage the controller 2 to initiate an upwards movement of the support tray member 20 traversing the support tray member 20 vertically through the interior volume 16 of the dry food module 15. Ensuing arrival at the upper end 18, the support tray member 20 is tiltably moved towards the hopper module 30. Hopper module 30 includes opening 31 providing access to the interior volume of the hopper module 30. The tiltable movement of the support tray member 20 provides a technique to assist a user in transferring the materials in an open pet food bag 99 into the hopper module 30.

The hopper module 30 includes a plurality of walls 33 integrally formed defining the interior volume of the hopper module 30. The bottom portion 34 of the hopper module 30 is tapered in form so as to facilitate directional control of the food mixture egressing therefrom. The bottom portion 34 has lower opening 35 that is configured to direct food into containers 40. The containers 40 are illustrated herein in a stacked formation wherein a plurality of containers 40 are arranged in a vertically stacked manner. Food egressing from the bottom portion 34 of the hopper module 30 is directed into the interior volume 41of the uppermost container 40. While the container 40 are illustrated in a particular shape herein, it is contemplated within the scope of the present invention that the containers 40 could be provided in alternate sizes and shapes. Furthermore, it should be understood within the scope of the present invention that only one container 40 could be placed underneath the hopper module 30 for receipt of food therein.

A milling module 50 is operably coupled to the hopper module 30. The milling module 50 is configured to introduce a second food type into the hopper module 30 so as to be mixed with the food type that is disposed within the hopper module 30. The milling module 50 includes within the interior volume thereof suitable mechanical elements that are operable to provide functions such as but not limited to grinding and processing of food materials prior to introducing the food material into the interior volume of the hopper module 30. The milling module 50 is operably coupled to the controller 2 which provides operation thereof. It should be understood within the scope of the present invention that the controller 2 includes the necessary electronics to receive, store, transmit and manipulate data so as to operate the animal feeder 100. The controller 2 includes interface 4 that provides a technique to operably engage with the controller 2.

A food supplement module 60 is operably coupled to the milling module 50 and is superposed thereto and coupled therewith utilizing delivery tube 61. The food supplement module 60 includes a plurality of walls 62 forming an interior volume that is operable to receive and store at least one additional type of food material or supplement. A door member 64 Is formed in the top 65 and provides access to the interior volume of the food supplement module 60. The food supplement module 60 introduces a food material or supplement into the milling module 50 wherein the material is processed and subsequently introduced into the hopper module 30. It should be understood within the scope of the present invention that the food supplement module 60 could be provided in alternate sizes and is configured to introduce both solid and liquid materials into the milling module 50.

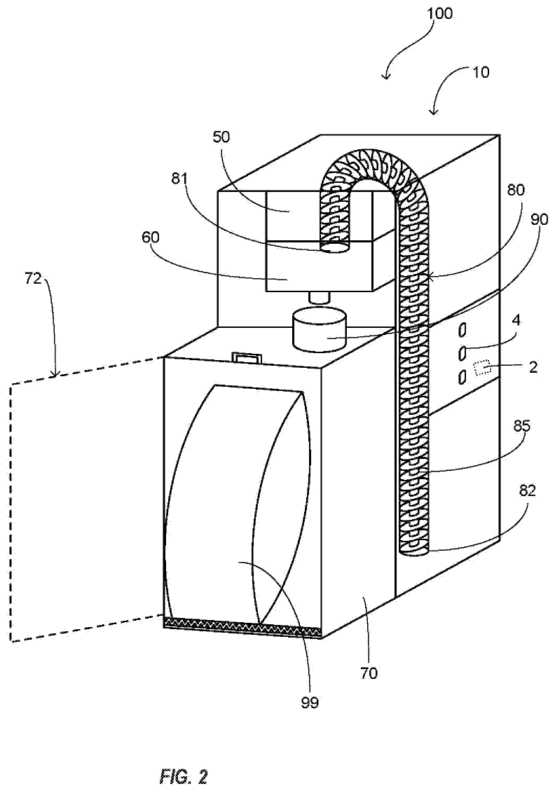

Referring in particular to FIG. 2, a second embodiment 10 of the animal feeder 100 is illustrated therein. The second embodiment 10 includes most of the same elements as the first embodiment 5 having a slightly different configuration and an alternate delivery technique as is further discussed herein. The second embodiment 10 includes a dry food module 70 that is configured to receive pet food bag 99 therein for storage thereof. The dry food module 70 of the second embodiment 10 includes door member 72 that is configured to provide access to the interior volume thereof. It is contemplated within the scope of the present invention that the door member 72 could hinge either from a sidewall as illustrated herein or from the bottom in order to either place the pet food bag 99 therein and leave in place or to transfer the food materials from the pet food bag 99 into the interior volume of the dry food module 70. The second embodiment 10 of the animal feeder 100 includes the food supplement module 60 and the milling module 50 that operate and function as previously described herein. As with the first embodiment 5, the second embodiment 10 includes the controller 2 and interface 4 providing operational control thereof.

The second embodiment 10 includes a delivery tube 80 wherein the delivery tube 80 is configured to transfer food material from the milling module 50 into a container (not illustrated herein) wherein the food material egresses from the second end 82 of the delivery tube 80. It is contemplated within the scope of the present invention that the first end 81 can be positioned in alternate locations for introduction of food material thereinto. The delivery tube 80 is manufactured from a flexible material so as to facilitate placing the first end 81 in alternate locations. The delivery tube 80 can receive food material from within the milling module 50 wherein food material has been transferred into the food supplement module 60 via the transfer member 90 which is operable to move food material upward from the dry food module 70 into the food supplement module 60. The delivery tube 80 includes an auger member 85 manufactured from a flexible material that is helical shaped and rotatably movable within the delivery tube 80. The auger member 85 functions to facilitate transfer of food material from the first end 81 of the delivery tube 80 to the second end 82 via rotational movement thereof. The first end 81 can be extended downward into the interior volume of the dry food module 70 in order to facilitate transfer of food material disposed therein, either in a bag or in the interior volume, to the second end 82 so as to bypass the milling module 50. It is contemplated within the scope of the present invention that the delivery tube 80 could be provided in alternate diameters and lengths.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An animal feeder that is configured to assist with management of a first food material and a second food material wherein the animal feeder comprises:
a dry food module, wherein the dry food module includes a plurality of walls defining an interior volume, said dry food module configured to receive and store therein the first food material;
a hopper module, said hopper module being operably coupled to said dry food module being adjacent thereto, said hopper module having a plurality of walls defining an interior volume, said hopper module having an opening at a top end thereof, said interior volume configured to receive the first food material from said dry food module, said hopper module having a bottom portion, said bottom portion being tapered in shape, said bottom portion having an opening, said bottom portion configured to direct a food mixture into a container;
a food supplement module, said food supplement module having a plurality of walls, a top and a bottom defining an interior volume, said food supplement module configured to receive the second food material therein;
a milling module, said milling module being operably coupled to said food supplement module, said milling module configured to provide processing of said second food material, said milling module being operably coupled to said hopper module, said milling module operable to introduce said second food material into said hopper module; and
a controller, said controller having electronics configured to receive, store, transmit and manipulate data, said controller configured to provide operation of the animal feeder.

2. The animal feeder that is configured to assist with management of the first food material and the second food material as recited in claim 1, and further including a support tray member, said support tray member being movably coupled within said dry food module, said support tray member configured to have a animal food bag superposed thereon.

3. The animal feeder that is configured to assist with management of the first food material and the second food material as recited in claim 2, wherein said support tray member is configured to move in a first direction and a second direction.

4. The animal feeder that is configured to assist with management of the first food material and the second food material as recited in claim 3, wherein the first direction of said support tray member is an upwards-downwards direction.

5. The animal feeder that is configured to assist with management of the first food material and the second food material as recited in claim 4, wherein the second direction of said support tray member is a tiltable movement.

6. The animal feeder that is configured to assist with management of the first food material and the second food material as recited in claim 5, wherein said second direction of said support tray member is operable to facilitate transfer of the first food material into said hopper module.

7. The animal feeder that is configured to assist with management of the first food material and the second food material as recited in claim 6, and further including a delivery tube, said delivery tube operably coupling said food supplement module to said milling module.

8. The animal feeder that is configured to assist with management of the first food material and the second food material as recited in claim 7, wherein said second food material can be either liquid or solid in form.

9. The animal feeder that is configured to assist with management of the first food material and the second food material as recited in claim 8, and further including a stack of a plurality of containers, said plurality of containers being arranged in a vertically stacked formation, wherein each container of said stack of plurality of containers is configured to receive and store a food mixture therein.

10. The animal feeder that is configured to assist with management of the first food material and the second food material as recited in claim 9, and further including an interface, said interface being operably coupled to said controller, said interface providing a technique to operate the animal feeder.

11. An animal feeder that is configured to assist with management of a first food material and a second food material wherein the animal feeder comprises:
a dry food module, wherein the dry food module includes a plurality of walls defining an interior volume, said dry food module configured to receive and store therein the first food material;
a food supplement module, said food supplement module having a plurality of walls, a top and a bottom defining an interior volume, said food supplement module configured to receive the second food material therein;
a milling module, said milling module being operably coupled to said food supplement module, said milling module configured to provide processing of said second food material, said milling module being operably coupled to said hopper module, said milling module operable to introduce said second food material into said hopper module;
a delivery tube, said delivery tube being flexible, said delivery tube having a first end and a second end, said delivery tube having a first opening at said first end, said delivery tube having a second opening at said second end, said delivery tube having a hollow passage therethrough, said delivery tube having an auger member, said auger member extending through said delivery tube between said first end and said second end, said auger member being rotatably mounted within said delivery tube, said delivery tube configured to transfer a mixture of the first food material and the second food material into a container; and
a controller, said controller having electronics configured to receive, store, transmit and manipulate data, said controller configured to provide operation of the animal feeder.

12. The animal feeder that is configured to assist with management of the first food material and the second food material as recited in claim 11, wherein said first end of said delivery tube is positionable in alternate locations.

13. The animal feeder that is configured to assist with management of the first food material and the second food material as recited in claim 12, wherein said dry food module is configured to have a bag of animal food disposed therein.

14. The animal feeder that is configured to assist with management of the first food material and the second food material as recited in claim 13, and further including a transfer member, said transfer member being operably coupled with said dry food module, said transfer member configured to transfer the first food material from said dry food module to said food supplement module.
